(19) United States
(12) Patent Application Publication
(10) Pub. No.: US 2013/0015736 A1
(43) Pub. Date: Jan. 17, 2013

(54) STATOR ASSEMBLY FOR MOTOR AND MOTOR INCLUDING THE SAME

(71) Applicant: Jong Min CHOI, Suwon (KR)

(72) Inventor: Jong Min CHOI, Suwon (KR)

(73) Assignee: SAMSUNG ELECTRO-MECHANICS CO., LTD., Suwon (KR)

(21) Appl. No.: 13/348,119

(22) Filed: Jan. 11, 2012

(30) Foreign Application Priority Data
Jul. 12, 2011 (KR) 10-2011-0068877

(51) Int. Cl. H02K 11/00

(52) U.S. Cl. 310/71

(57) ABSTRACT

There is provided a stator assembly for a motor, the stator assembly including: a base; and a reinforcing part coupled to the base and including a core coupling part having a core coupled thereto, the core having a coil wound therearound, and a disconnection prevention part extended from an end portion of the core coupling part along one surface of the base to thereby prevent a contact between the lead wire of the coil and the base.

### CROSS-REFERENCE TO RELATED APPLICATIONS

This application claims the priority of Korean Patent Application No. 10-2011-0068877 filed on Jul. 12, 2011, in the Korean Intellectual Property Office, the disclosure of which is incorporated herein by reference.

### BACKGROUND OF THE INVENTION

1. Field of the Invention

The present invention relates to a stator assembly for a motor and a motor including the same, and more particularly, to a motor for use in a hard disk drive (HDD) rotating a recording disk.

2. Description of the Related Art

A hard disk drive (HDD), a computer information storage device, reads data stored on a disk or writes data to the disk using a magnetic head.

In a hard disk drive, a base has a head driver installed thereon, that is, a head stack assembly (HSA), capable of altering a position of the magnetic head relative to the disk. The magnetic head performs its function while moving to a required position in a state in which it is suspended above a writing surface of the disk by the head driver at a predetermined height.

According to the related art, in manufacturing a base provided in a hard disk drive, a post-processing scheme of die-casting aluminum (Al) and then removing burrs or the like, generated due to the die-casting, has been used.

However, in the die-casting scheme according to the related art, since a process of injecting molten aluminum (Al) for casting a base is performed, high temperatures and pressure are required, such that a large amount of energy is required in the process and a process time may be increased.

Further, in terms of a die-casting mold lifespan, there is a limitation in manufacturing a large number of bases using a single mold, and a base manufactured by the die-casting process may have poor dimensional precision.

Therefore, in order to solve defects generated in the die-casting process, a base has been manufactured using a pressing or forging process. However, in the case of manufacturing a base using the pressing or forging process, the base can only have a uniform thickness, such that it may be difficult to implement a precise shape.

Therefore, research into a technology capable of implementing a precise part, even in the case of using a press or forging process, is urgently required.

### SUMMARY OF THE INVENTION

An aspect of the present invention provides a stator assembly for a motor having improved vibration resistance and impact resistance and preventing disconnection of a coil lead wire due to contact between the coil lead wire and a base by effectively implementing a part to which a core is coupled, requiring precision and rigidity even in the case of using a pressing or forging process, and a motor including the same.

According to an aspect of the present invention, there is provided a stator assembly for a motor, the stator assembly including: a base through which a coil lead wire generating rotational driving force in the motor passes; and a reinforcing part coupled to the base and including a core coupling part having a core coupled thereto, the core having a coil wound therearound, and a disconnection prevention part extended from an end portion of the core coupling part along one surface of the base to thereby prevent a contact between the lead wire of the coil and the base.

The base may include a fixing part protruded while having a hollow therein, and the core coupling part may be inserted onto an outer peripheral surface of the fixing part to thereby be fixed thereto.

The disconnection prevention part may be extended while contacting one surface of the base.

The base may include a coil lead part through which the lead wire of the coil passes, and the disconnection prevention part may include a coil penetration part that is in communication with the coil lead part.

The coil penetration part may have a diameter smaller than that of the coil lead part.

The core coupling part may include a seat part forming a step on the outer peripheral surface thereof to thereby allow the core to be seated thereon.

The base may be formed by press processing.

The reinforcing part may be formed of a non-conductive material.

According to another aspect of the present invention, there is provided a motor including: the stator assembly for a motor as described above; a sleeve coupled to the base and supporting the shaft; and a hub having a magnet coupled thereto so as to rotate together with the shaft, the magnet facing the core having the coil wound therearound.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a stator assembly for a motor according to an embodiment of the present invention;

FIG. 2 is a schematic cut-away perspective view showing the stator assembly for a motor according to the embodiment of the present invention; and

FIG. 3 is a schematic exploded perspective view showing the stator assembly for a motor according to the embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

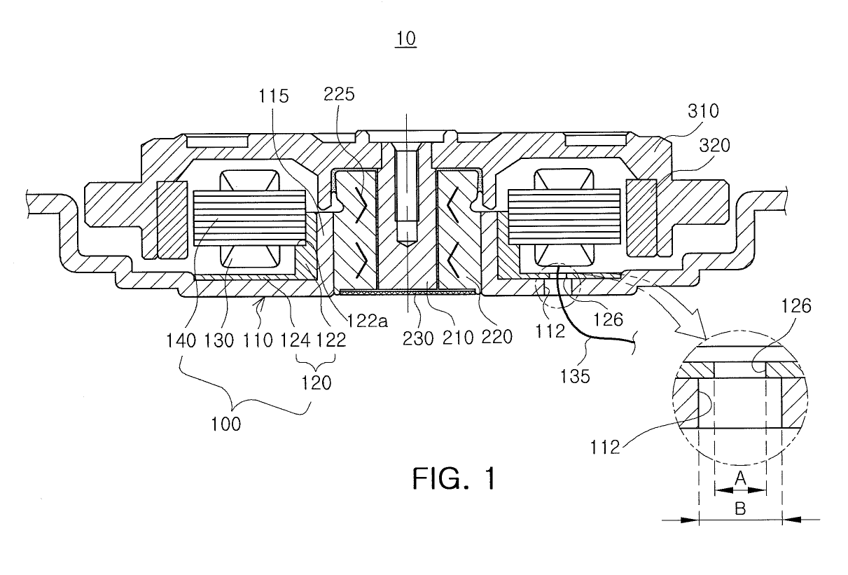

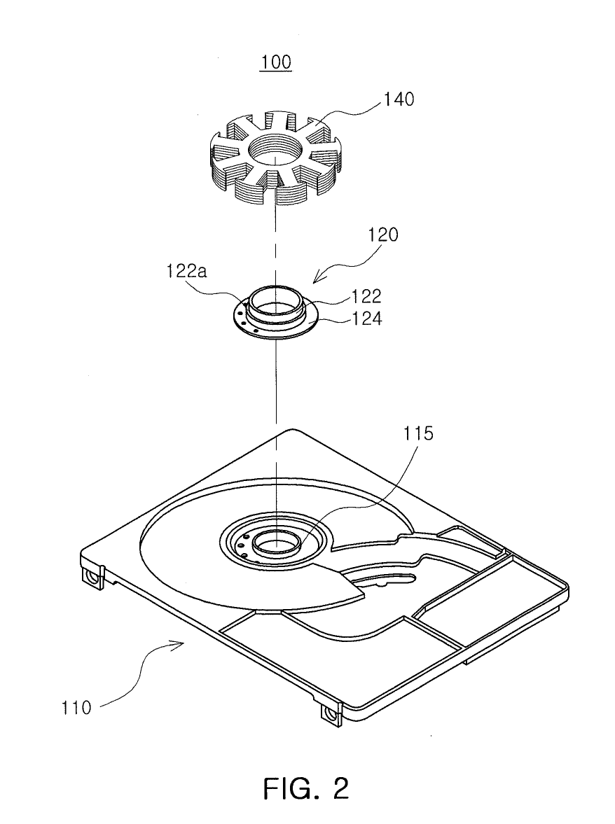

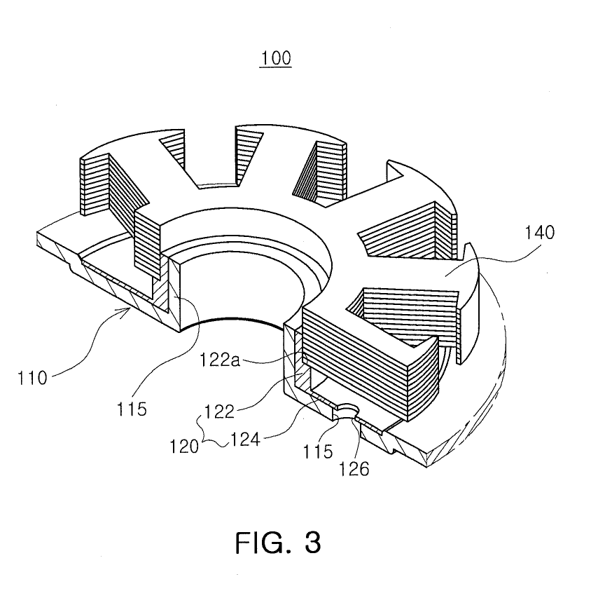

FIG. 1 is a schematic cross-sectional view showing a motor including a stator assembly for a motor according to an embodiment of the present invention; FIG. 2 is a schematic cut-away perspective view showing the stator assembly for a motor according to the embodiment of the present invention; and FIG. 3 is a schematic exploded perspective view showing the stator assembly for a motor according to the embodiment of the present invention.

Referring to FIGS. 1 through 3, the motor 10 including a stator assembly 100 for a motor according to the embodiment of the present invention may include the stator assembly 100 for a motor (hereinafter, referred to as a “stator assembly”) including a base 110 and a reinforcing part 120, a sleeve 220 supporting a shaft 210, and a hub 310 having a magnet 320 coupled thereto.

Terms with respect to directions will be first defined. As viewed in FIG. 1, an axial direction refers to a vertical direction based on the shaft 210, and an outer diameter or inner diameter direction refers to a direction towards an outer edge of a hub 310 based on the shaft 210 or a direction towards the center of the shaft 210 based on the outer edge of the hub 310.

In addition, a circumferential direction refers to a direction in which the shaft 210 rotates along an outer peripheral surface thereof.

The stator assembly 100 may include the base 110 having a core 140 coupled thereto and the reinforcing part 120 having the core 140 coupled thereto and preventing disconnection of a coil lead wire 135, wherein the core 140 has a coil 130 wound therearound. A description thereof will be provided after other components of the motor 10 according to the embodiment of the present invention are described.

The sleeve 220 may support the shaft 210 such that an upper end of the shaft 210 protrudes upwardly in an axial direction, and may be formed by forging Cu or Al or sintering Cu—Fe based alloy powders or SUS based powders.

Here, the shaft 210 may be inserted into a shaft hole of the sleeve 220, having a micro clearance therebetween. The micro clearance may be filled with oil, and the rotation of the shaft 210 may be more stably supported by a fluid dynamic pressure part 225 formed in at least one of an outer peripheral surface of the shaft 210 and an inner peripheral surface of the sleeve 220.

The fluid dynamic pressure parts 225 may generate radial dynamic pressure via the oil and may be formed at each of upper and lower portions of the sleeve 220 in order to more effectively support the shaft 210 by the radial dynamic pressure.

However, the fluid dynamic parts 225 may also be formed in the outer peripheral surface of the shaft 210 as well as in the inner peripheral surface of the sleeve 220 as described above. In addition, the number of fluid dynamic parts 225 is not limited.

Here, the fluid dynamic part 225 may be a groove having a herringbone shape, a spiral shape, or a screw shape. However, the fluid dynamic part 226 is not limited to having the above-mentioned shape but may have any shape as long as the radial dynamic pressure may be generated by the rotation of the shaft 210.

Further, the sleeve 220 may include a base cover 230 coupled to a lower portion thereof so as to close the lower portion thereof. The motor 10 according to the embodiment of the present invention may be formed in a full-fill structure by the base cover 230.

The hub 310 may be a rotating structure rotatably provided with respect to the fixed member including the base 110.

In addition, the hub 310 may include an annular ring shaped magnet 320 provided on an inner peripheral surface thereof, wherein the annular ring shaped magnet 320 corresponds to the core 140, having a predetermined interval therebetween.

Here, the magnet 320 interacts with the coil 130 wound around the core 140, whereby the motor 10 according to the embodiment of the present invention may obtain rotational driving force.

The stator assembly 100 may include the base 110 and the reinforcing part 120 that are manufactured using a press or forging process.

Here, the base 110 may be a fixed member supporting rotation of a rotating member including the shaft 210 and the hub 310 with respect to the rotating member.

In addition, the base 110 may include a fixing part 115 protruded upwardly in the axial direction while having a hollow so that the sleeve 220 is coupled thereto, and the sleeve 220 may be coupled to the base 110 by being inserted into the hollow, which is an internal space of the fixing part 115.

Here, as a method for coupling the base 110 and the sleeve 220 to each other, a method such as a bonding method, a welding method, a press-fitting method, or the like, may be used.

Here, a process of manufacturing the base 110 will be schematically described. According to the related art, a die-casting scheme has been used. In the die-casting scheme according to the related art, since a process of injecting molten aluminum (Al) for casting a base is performed, high temperature and pressure may be required, such that a large amount of energy is required in the process and a process time is increased.

Further, in terms of a die-casting mold lifespan, there is a limitation in manufacturing a large number of bases using a single mold, and a base manufactured by the die-casting process has poor dimensional precision.

Therefore, according to the embodiment of the present invention, the base 110 may be formed by a press or forging process in order to solve defects in the die-casting process.

More specifically, in the base 110 according to the embodiment of the present invention, a basic configuration may be formed by performing a press or forging process on a cold rolled steel sheet (SPCC, SPCE, or the like) or a hot rolled steel sheet. Then, the entire shape may be completed by performing a post process such as a bending process, a cutting process, and the like.

In the case of manufacturing the base 110 using the press or forging process, a steel based steel sheet may be used as a material of the base 110 as described above. The steel based steel sheet has strengths in that it has an elastic modulus higher than that of aluminum (Al) used in the die-casting process according to the related art, but has a defect in that it has density higher than that of Al.

Therefore, in the case of manufacturing the base 110 using the press or forging process, a steel based steel sheet that is as thin as possible, that is, a steel sheet material having a thickness of 1 mm or less needs to be used. As a result, the base 110 may also have a relatively thin thickness.

The base 110 manufactured by the press or forging process as described above basically has a uniform thickness and is weak in terms of a degree of freedom in an increase and a decrease in a thickness.

This may imply that it is difficult to form a part to which the sleeve 220 and the core 140 having the coil 130 wound therearound are coupled, the sleeve 220 and the core 140 having a relatively thick thickness and so requiring rigidity, particularly in the base 110.

Therefore, in the case of forming the base 110 by the press or forging process, an additional component to which the core 140 having the coil 130 wound therearound is to be coupled is required, which may be solved by the reinforcing part 120 including a core coupling part 122 and a disconnection prevention part 124 in the base 110 according to the embodiment of the present invention.

More specifically, the reinforcing part 120 may include the core coupling part 122 for coupling the core 140 to the base 110 and the disconnection prevention part 124 extended from an end portion of the core coupling part 122 along one surface of the base 110 to thereby prevent disconnection of the coil lead wire 135 due to a contact between the coil lead wire 135 and the base 110.

Here, the core coupling part 122 may be inserted onto an outer peripheral surface of the fixing part 115 of the base 110 so as to be coupled to the base 110. As a coupling method, a bonding method, a welding method, a press-fitting method, or the like, may be used.

In addition, the core coupling part 122 may be continuously formed along the outer peripheral surface of the fixing part 115 in the circumferential direction and include a seat part 122a for seating the core 140 thereon.

In addition, the seating part 122a may be formed to have a step on the outer peripheral surface of the core coupling part 122 to thereby seat the core 140 thereon and support a coreback around which the coil 130 is not wound in a configuration of the core 140, to thereby fix the core 140 thereon.

The disconnection prevention part 124 may be extended from an end portion of an axial lower portion of the core coupling part 122 in the outer diameter direction and prevent the disconnection of the coil lead wire 135 due to the contact between the coil lead wire 135 and the base 110.

In addition, the disconnection prevention part 124 may also be extended in the outer diameter direction in a state in which it contacts one surface of the base 110.

Here, describing a coil lead part 112 allowing the coil lead wire 135 to penetrate through the base 110, the coil lead part 112 may be at least one hole formed in the base 110 so as to lead the coil lead wire 135 to the outside.

More specifically, the number of coil lead parts 112 may be 4, which is plural. The reason is that the coil 130 may be a three-phase coil, that is, a u-phase coil, a v-phase coil, and a w-phase coil.

In other words, one ends of the respective u-phase, v-phase, and w-phase coils may be common parts, and the respective common parts may be treated as a single part, which may form four coil lead wires 135 together with the other ends of the u-phase, v-phase, and w-phase coils.

However, only a single coil lead wire 135 is shown in FIG. 1 for convenience.

Therefore, four coil lead parts 112 may be formed so that each of the four coil lead wires 135 penetrates therethrough.

However, the number of coil lead parts 112 is not limited to four as described above, but may also be one or plural other than four.

In addition, although not shown in FIG. 1, the coil lead wire 135 may pass through the coil lead part 112 formed in the base 110 to thereby be electrically connected to a printed circuit board (not shown) disposed at an outer side of the base 110 in order to supply power.

In the configuration, the coil lead wire 135 needs to be maintained so as not to contact the base 110. At the time of contact between the coil lead wire 135 and the base 110, a defect may occur due to the disconnection.

Therefore, a component for maintaining the coil lead wire 135 so as not to contact the base 110 is required, which may be solved by the disconnection prevention part 124 in the present invention.

That is, in the disconnection prevention part 124, which is one component of the reinforcing part 120, a coil penetration part 126 may be formed in a region corresponding to the coil lead part 112 formed in the base 110, wherein the coil lead part 112 and the coil penetration part 126 may be in communication with each other.

However, in order to prevent the disconnection of the coil lead wire 135 due to the contact between the coil lead wire 135 and the base 110, which may be generated in the case in which the coil lead wire 135 penetrates through the coil lead part 112, the coil penetration part 126 may have a diameter A smaller than a diameter B of the coil lead part 112.

Further, in order to prevent the disconnection of the coil lead wire 135 due to a contact between the coil lead wire 135 and a sidewall of the coil penetration part 126, that is, the disconnection prevention part 124, the disconnection prevention part 124 may be formed of a non-conductive material.

Here, since the disconnection prevention part 124 may be formed integrally with the core coupling part 122, the entire material of the reinforcing part 120 may be a non-conductive material.

Additionally, the disconnection prevention part 124 may be formed to correspond to an adjacent region of the core lead part 112 formed in the base 110. That is, the disconnection prevention part 124 may be formed in an arc shape in the circumferential direction.

As described above, in the motor 10 according to the embodiments of the present invention, the part to which the coil 140 is coupled, requiring precision and rigidity may be effectively implemented by the reinforcing part 120 including the core coupling part 122 even in the case of using the press or forging process.

In addition, the rigidity of the part to which the core 140 is coupled is improved, whereby the entire vibration resistance and impact resistance may be significantly improved.

Further, the contact between the coil lead wire 135 and the base 110 may be prevented by the disconnection prevention part 124, which is one component of the reinforcing part 120, whereby a defect due to the disconnection may be significantly reduced.

Additionally, a component for coupling the core 140 to the base 110 and preventing the disconnection of the coil lead wire 135 occurring due to contact between the coil lead wire 135 and the base 110 may be solved by the reinforcing part 120, a single component, whereby assembly may be significantly easily performed and productivity may be significantly increased.

As set forth above, with the stator assembly for a motor and the motor including the same according to the embodiments of the present invention, the part to which the core is coupled, requiring precision and rigidity, may be effectively implemented even in the case of using the press or forging process.

In addition, the rigidity of the part to which the core is coupled may be improved, whereby the entire vibration resistance and impact resistance may be significantly improved.

Further, the base and the core may be easily assembled to each other and a separate insulating member is not required, whereby the productivity may be significantly increased.

While the present invention has been shown and described in connection with the embodiments, it will be apparent to those skilled in the art that modifications and variations can be made without departing from the spirit and scope of the invention as defined by the appended claims.

What is claimed is:

1. A stator assembly for a motor, the stator assembly comprising:
a base through which a coil lead wire generating rotational driving force in the motor passes; and
a reinforcing part coupled to the base and including a core coupling part having a core coupled thereto, the core having a coil wound therearound, and a disconnection prevention part extended from an end portion of the core coupling part along one surface of the base to thereby prevent a contact between the lead wire of the coil and the base.

2. The stator assembly of claim 1, wherein the base includes a fixing part protruded while having a hollow therein, and the core coupling part is inserted onto an outer peripheral surface of the fixing part to thereby be fixed thereto.

3. The stator assembly of claim 1, wherein the disconnection prevention part is extended while contacting one surface of the base.

4. The stator assembly of claim 1, wherein the base includes a coil lead part through which the lead wire of the coil passes, and the disconnection prevention part includes a coil penetration part that is in communication with the coil lead part.

5. The stator assembly of claim 4, wherein the coil penetration part has a diameter smaller than that of the coil lead part.

6. The stator assembly of claim 1, wherein the core coupling part includes a seat part forming a step on the outer peripheral surface thereof to thereby allow the core to be seated thereon.

7. The stator assembly of claim 1, wherein the base is formed by press processing.

8. The stator assembly of claim 1, wherein the reinforcing part is formed of a non-conductive material.

9. A motor comprising:
the stator assembly for a motor of claim 1;
a sleeve coupled to the base and supporting the shaft; and
a hub having a magnet coupled thereto so as to rotate together with the shaft, the magnet facing the core having the coil wound therearound.
